(19) United States
(12) Patent Application Publication
(10) Pub. No.: US 2025/0130851 A1
(43) Pub. Date: Apr. 24, 2025

(54) CLOUD SCHEDULER

(71) Applicant: VMware LLC, Palo Alto, CA (US)

(72) Inventors: Sudershan Bhandari, Burlington, MA (US); Rushikesh Vyas, Burlington, MA (US); Alexey Grunkov, Boulder, CO (US); Senthil Prabhu Thirumurthy, Palo Alto, CA (US)

(73) Assignee: VMware LLC, Palo Alto, CA (US)

(21) Appl. No.: 18/382,122

(22) Filed: Oct. 20, 2023

(51) Int. Cl. G06F 9/48; G06F 9/455; G06F 9/54

(52) U.S. Cl. CPC G06F 9/4881; G06F 9/45558; G06F 9/547; G06F 2009/4557

(57) ABSTRACT

The present disclosure is related to devices, systems, and methods for a cloud scheduler. An example method can include receiving a schedule associated with an automation task to be performed in a virtualized environment via a REST API, wherein the task is associated with a target, associating the schedule with a partition, storing the schedule in a cache store responsive to determining that the schedule is to be invoked within a threshold time period, and receiving the schedule from the cache store and invoking the target responsive to the schedule becoming overdue.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for a cloud scheduler according to one or more embodiments of the present disclosure.

FIG. 2 illustrates an architecture for a cloud scheduler according to one or more embodiments of the present disclosure.

FIG. 3 illustrates a system for a cloud scheduler according to one or more embodiments of the present disclosure.

FIG. 4 is a diagram of a machine for a cloud scheduler according to one or more embodiments of the present disclosure.

### DETAILED DESCRIPTION

Virtualization and cloud computing enterprises (e.g., VMware) provide a suite of solutions to optimize multi-cloud environments for cost, performance, security, compliance, and other criteria. They can play a pivotal role in achieving consistency in operations by providing a centralized gateway to multi-cloud. The power of the software platform lies in automating every manageable step, which is key in delivering efficient and more intelligent management across all clouds. Enabling automation in each operation reduces manual overheads and facilitates a self-service user experience for our multi-cloud consumers. Many times, automation tasks need to be performed at a specific time of day or on a recurring schedule, which results in an added burden to consumers. Embodiments of the present disclosure can extend automation capabilities with scheduling. For instance, embodiments herein can promote scheduling as a first-class citizen in any automation with a fully managed scheduler service. With such a built-in capability at the platform level, it becomes possible for scheduling cross-service cross-cloud automation. This gives a cost-efficient edge over the individual public or private cloud scheduling services. In some instances, one or more embodiments of the present disclosure may be referred to as a “cloud scheduler.”

When considering DevOps operations or automation, typically the first thing that comes to mind is «cron». Cron usually comes with its management and maintenance overhead of computing, personnel, etc., especially when application tasks are to be scheduled reliably at scale. Embodiments herein can hide cron overheads by providing a scheduling solution based on distributed systems' key characteristics and making scheduling application tasks more convenient and centralized.

The scheduler service in accordance with embodiments herein can support multitenancy and work with various platforms (e.g., VMware Common Service Platform (CSP)). Other products or applications can onboard quickly on scheduler service within the scope of these platforms. It can provide an interface to schedule future invocations of virtually any task, defined as an HTTP endpoint within an on-premises cloud or an external public cloud, once or at a recurring pattern by leveraging cron expressions.

Embodiments herein can invoke tasks reliably at least once with limited retries (to mitigate failures) within a few seconds of the actual scheduled time. It supports dynamic horizontal scaling to accommodate millions of task invocations in a multi-tenant environment. It can expose a unified REST API and UI that any consumer, either a user or another cloud service, can leverage to define its scheduling needs and access retrospective details of task invocations within the tenant boundaries. For instance, a tenant user could schedule execution of pipelines in a release automation solution (e.g., vRealize Code Stream) or periodically reclaim outdated virtual machine snapshots in a management platform (e.g., vRealize Operations) or CSP can schedule onboarding or offboarding of a customer tenant on a Cloud.

Previous approaches introduce scheduling scoped within a product boundary. The efforts to develop such features are redundant and time-consuming. Hence, the scheduling capabilities slowly appear across multiple product releases in a very limited scope. The customers are left to use other providers for scheduling until then or open a feature request and wait for future releases. Embodiments of the present disclosure offer scheduling enablement in a much faster way for any automation in the product to give a better user experience. Embodiments herein also provide a system architecture to scale reliably for scheduling tens of thousands of automations across multiple tenants for many products.

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

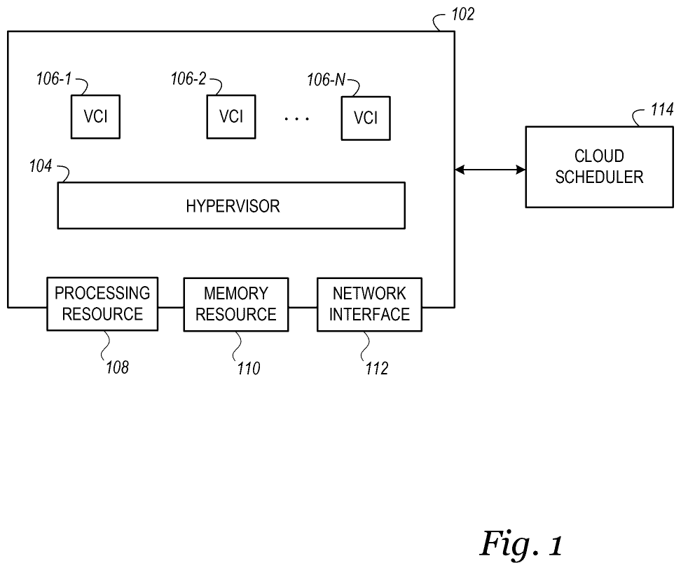

FIG. 1 is a diagram of a host and a system for a cloud scheduler according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a cloud scheduler 114. An example of the cloud scheduler 114 is illustrated and described in more detail below. In some embodiments, the cloud scheduler 114 can be a server, such as a web server.

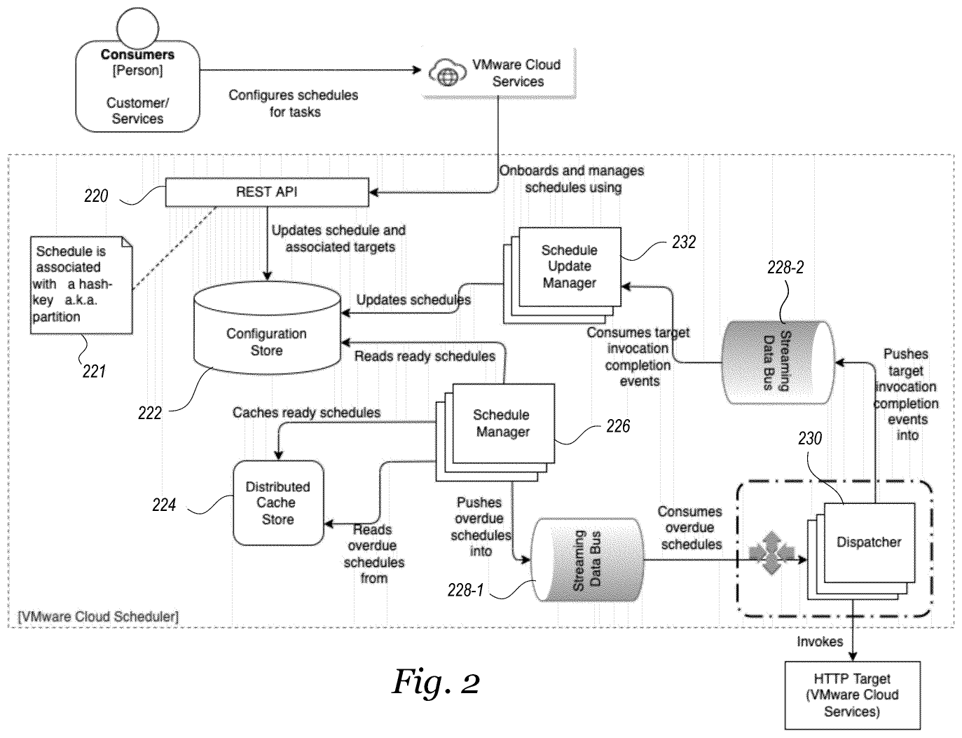

FIG. 2 illustrates an architecture for a cloud scheduler according to one or more embodiments of the present disclosure. It is noted that the architecture illustrated in FIG. 2 references the specific example of VMware Cloud Services, though embodiments of the present disclosure are not so limited. The architecture illustrated in FIG. 2 can achieve goals including making one-time and/or recurring task invocations easier with a frequency defined as a cron expression, reliability, accuracy, and high availability, and dynamic scalability to support large numbers of task invocations at a given time.

As shown in FIG. 2, the architecture includes a REST API 220. The REST API 220 provides a configuration interface for onboarding of scheduled tasks. Any task can become a “target” in the scheduler service's configuration store 222. The consumer can use the REST API 220 to configure schedule and target invocation strategy. The target is an endpoint (HTTP, pub/sub, etc.) that the scheduler service will call into at a designated schedule. The consumer of the REST API 220 provides the payload, headers and other contextual metadata for invoking the target successfully. This metadata can be stored as base-64 encoded artifacts in the configuration store 222. The configuration could also include retry attempts on failure. The consumer can provide a timestamp for running the automation once in future or configure a recurring cron. The schedule can be configured to expire at a certain time in the future.

An example schedule configuration request to invoke an HTTP endpoint can be:

```
curl -location -request POST ‘https://vcs.vmware.com/schedules; \
--header ‘Authorization: Bearer {{user-token}}; \
--header ‘Content-Type: application/json; \
--data-raw ;{
  “name : <schedule-configuration-name>”,
  “description” : “<schedule-configuration-description>”,
  “applicationID” : “<onboarded-applicationID>”,
  “cron” : “cron-expression”, // cron format - * * * * *,
  “expireAt” : “<optional-field-for-expiring-scheduled-invocation>”,
  //If need to be run only once
  “nextInvocationAt” : “<iso-8601-timestamp>”,
  “httpTarget” : {
    “url” : “<http-url>”,
    “method” : “<http-method>”, // POST, PUT, PATCH, etc.
    “headers” : [{“key1” : “value1”}, {“key2” : “value2”}],
    “body” : “<http-request-metadata>”
  }
}
```

The consumer can authorize with service credentials or organization-level user tokens when configuring schedules. One can also use the provided REST API 220 to cancel the scheduled automation task. The service also provides historical target invocations via the same API 220.

A partition 221 is a hash-key that is assigned to a schedule in the service. One partition 221 can be associated with a limited number of schedules (e.g., 5000 schedules per partition). A default partition is created per application, or a service onboarded on the scheduler. Partitions 221 can be scaled up or down based on the demand for a given consumer. The advantage of partitioning is that overwhelming number of overdue target invocations can be queued in parallel instead of queuing sequentially; it greatly reduces the latency of target invocations when there are many (e.g., thousands) of pending targets at a given time.

A schedule manager 226 can be responsible for reading ready schedules from the configuration store 222 and/or cache store 224 and pushing them into a streaming data bus 228-1. The schedule manager 226 can run two tickers. The first ticker fetches from the configuration store 222 the schedules with a target invocation expected within a minute from «now» and pushes them into the cache store 224. The second ticker (which runs every second) reads any overdue schedules from the cache store 224 and pushes them into the streaming message queue/data bus 228-1. The manager 226 claims a partition in its tickers so that only one manager 226 is working on a single partition at a given time. Any service node can claim the partition. It makes the scheduler service highly available and promotes concurrency when handling schedules in isolation established by the partitions.

The cache store 224 temporarily holds schedules with targets to invoke now or overdue. The cache store 224 is optimized for faster reads to support accuracy of invocations when the service deals with massive arrays of schedules. The cache store 224 is a distributed and highly available component.

The streaming data bus 228-1 is a «pub/sub» component that enables real-time delivery of the overdue schedules to dispatchers 230. To promote scalability and reduce latency of the target invocations, the bus 228-1 is based on streaming fundamentals (e.g., push to consumers) and supports multiple concurrent subscriptions such that it forms consumer groups for a single stream. The bus 228-1 can provide gateway to multiple data streams. There is a default stream (or queue) per application partition.

The dispatcher 230 receives overdue schedules from the streaming data bus 228 and invokes the associated targets. It is a stateless lightweight component created to handle an individual partition. Several dispatchers 230 across nodes can form a cluster to handle the same partition. The overdue target invocations are delivered to only one dispatcher 230 at the most. Dispatchers 230 also auto-scale up or down depending on the load. After target invocation is finished, the dispatcher 230 pushes result of invocation into another streaming data bus 228-2 to update the configuration store 222 and record the invocation for reporting purposes. The dispatcher 230 retries on transient failures of task invocations according to the strategy defined in the schedule configuration; eventually, it will fail the invocation once the retry limit is exceeded.

In operation, a consumer/service's tenant user creates a schedule for a target using the REST API 220. The schedule is associated with an available hash-key (a.k.a. partition) 221. The next-invocation-time is evaluated and updated in the configuration store (PostgreSQL). The first schedule manager 226 ticker reads the schedule from the store 222 to determine if it is due to be invoked in a next minute. The schedule manager 226 pushes the schedule into the cache store 224 (Redis Cache). Another schedule manager 226 ticker (runs every second) reads the schedule from the cache store 224. It pushes this schedule into the streaming data bus 228-1 as soon as it becomes overdue. The dispatcher 230 consumes the schedule and invokes the target associated with it. Once it is done, the dispatcher 230 pushes a completion event back to the streaming data bus 228-2. The schedule Update Manager 232 consumes the completion event and updates the configuration store 222 with invocation results and next-invocation-time for the associated target.

Any service (e.g., VMware service) can onboard itself on this managed scheduler service by authenticating with CSP using the service's provided onboarding REST APIs and provide a valid authentication token when configuring/managing schedule configurations. A default partition is assigned to the service whenever a configuration is created, so that any new schedule can be configured for the service right away.

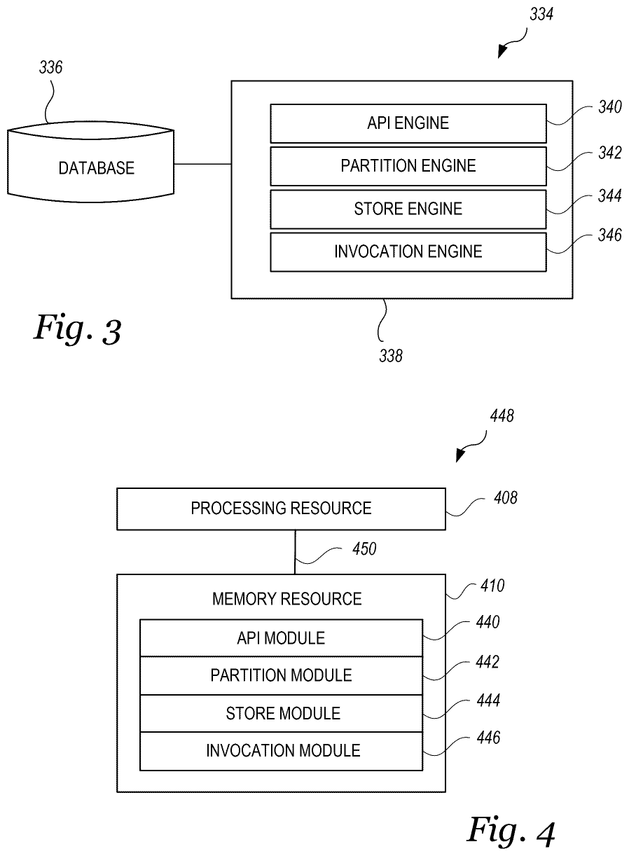

FIG. 3 illustrates a system 334 for a cloud scheduler according to one or more embodiments of the present disclosure. The system 334 can include a database 336, a subsystem 338, and/or a number of engines, for example API engine 340, partition engine 342, store engine 344, and/or invocation engine 346, and can be in communication with the database 336 via a communication link. The system 334 can include additional or fewer engines than illustrated to perform the various functions described herein. The system 334 can represent program instructions and/or hardware of a machine (e.g., machine 448 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the API engine 340 can include a combination of hardware and program instructions that is configured to receive a schedule associated with an automation task to be performed in a virtualized environment via a REST API, wherein the task is associated with a target. In some embodiments, the partition engine 342 can include a combination of hardware and program instructions that is configured to associate the schedule with a partition. In some embodiments, the store engine 344 can include a combination of hardware and program instructions that is configured to store the schedule in a cache store responsive to determining that the schedule is to be invoked within a threshold time period. In some embodiments, the invocation engine 346 can include a combination of hardware and program instructions that is configured to receive the schedule from the cache store and invoke the target responsive to the schedule becoming overdue.

FIG. 4 is a diagram of a machine 448 for a cloud scheduler according to one or more embodiments of the present disclosure. The machine 448 can utilize software, hardware, firmware, and/or logic to perform a number of functions. The machine 448 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 448 (e.g., the machine 448 can include internal memory resources and have access to external memory resources). In some embodiments, the machine 448 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as processing streams of change events). The set of MRI can be executable by one or more of the processing resources 408. The memory resources 410 can be coupled to the machine 448 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 408 can be coupled to the memory resources 410 via a communication path 450. The communication path 450 can be local or remote to the machine 448. Examples of a local communication path 450 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 450 can be such that the memory resources 410 are remote from the processing resources 408, such as in a network connection between the memory resources 410 and the processing resources 408. That is, the communication path 450 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 440, 442, 444, 446 that when executed by the processing resources 408 can perform a number of functions. As used herein a module includes a set of instructions included to perform a particular task or action. The number of modules 440, 442, 444, 446 can be sub-modules of other modules. For example, the partition module 442 can be a sub-module of the API module 440 and/or can be contained within a single module. Furthermore, the number of modules 440, 442, 444, 446 can comprise individual modules separate and distinct from one another. Examples are not limited to the specific modules 440, 442, 444, 446 illustrated in FIG. 4.

One or more of the number of modules 440, 442, 444, 446 can include program instructions and/or a combination of hardware and program instructions that, when executed by a processing resource 408, can function as a corresponding engine as described with respect to FIG. 3. For example, the API module 440 can include program instructions and/or a combination of hardware and program instructions that, when executed by a processing resource 408, can function as the API engine 304.

For example, the machine 448 can include an API module 440, which can include instructions to receive a schedule associated with an automation task to be performed in a virtualized environment via a REST API, wherein the task is associated with a target. For example, the machine 448 can include a partition module 442, which can include instructions to associate the schedule with a partition. For example, the machine 448 can include a store module 444, which can include instructions to store the schedule in a cache store responsive to determining that the schedule is to be invoked within a threshold time period. For example, the machine 448 can include an invocation module 446, which can include instructions to receive the schedule from the cache store and invoke the target responsive to the schedule becoming overdue.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 208 in FIG. 2. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a schedule associated with an automation task to be performed in a virtualized environment via a REST API, wherein the task is associated with a target;
associating the schedule with a partition;
storing the schedule in a cache store responsive to determining that the schedule is to be invoked within a threshold time period; and
receiving the schedule from the cache store and invoking the target responsive to the schedule becoming overdue.

2. The method of claim 1, wherein the target is a hypertext transfer protocol (HTTP) endpoint.

3. The method of claim 1, wherein the partition is a hash-key configured to be associated with a plurality of schedules.

4. The method of claim 1, wherein the method includes updating a configuration store with a result of the invocation of the target.

5. The method of claim 4, wherein the method includes updating the configuration store with a next invocation time associated with the target according to the schedule.

6. The method of claim 1, wherein the method includes re-invoking the target, according to a strategy defined in a configuration of the schedule, responsive to a failure to invoke the target.

7. The method of claim 1, wherein the method includes receiving, via the REST API:
a name of the schedule;
a description of the schedule;
a cron expression associated with the schedule; and
an expiration time of the schedule.

8. A non-transitory machine-readable medium having instructions stored thereon which, when executed by a processor, cause the processor to:
receive a schedule associated with an automation task to be performed in a virtualized environment via a REST API, wherein the task is associated with a target;
associate the schedule with a partition;
store the schedule in a cache store responsive to determining that the schedule is to be invoked within a threshold time period; and
receive the schedule from the cache store and invoke the target responsive to the schedule becoming overdue.

9. The medium of claim 8, wherein the target is a hypertext transfer protocol (HTTP) endpoint.

10. The medium of claim 8, wherein the partition is a hash-key configured to be associated with a plurality of schedules.

11. The medium of claim 8, including instructions to update a configuration store with a result of the invocation of the target.

12. The medium of claim 11, including instructions to update the configuration store with a next invocation time associated with the target according to the schedule.

13. The medium of claim 8, including instructions to re-invoke the target, according to a strategy defined in a configuration of the schedule, responsive to a failure to invoke the target.

14. The medium of claim 8, including instructions to receive, via the REST API:
a name of the schedule;
a description of the schedule;
a cron expression associated with the schedule; and
an expiration time of the schedule.

15. A system, comprising:
an API engine configured to receive a schedule associated with an automation task to be performed in a virtualized environment via a REST API, wherein the task is associated with a target;
a partition engine configured to associate the schedule with a partition;
a store engine configured to store the schedule in a cache store responsive to determining that the schedule is to be invoked within a threshold time period; and
an invocation engine configured to receive the schedule from the cache store and invoke the target responsive to the schedule becoming overdue.

16. The system of claim 15, wherein the target is a hypertext transfer protocol (HTTP) endpoint.

17. The system of claim 15, wherein the partition is a hash-key configured to be associated with a plurality of schedules.

18. The system of claim 15, wherein the invocation engine is configured to update a configuration store with a result of the invocation of the target.

19. The system of claim 18, wherein the invocation engine is configured to update the configuration store with a next invocation time associated with the target according to the schedule.

20. The system of claim 15, wherein the invocation engine is configured to re-invoke the target, according to a strategy defined in a configuration of the schedule, responsive to a failure to invoke the target.
